(19) United States
(12) Patent Application Publication
(10) Pub. No.: US 2010/0141180 A1
(43) Pub. Date: Jun. 10, 2010

(54) Light Source System

(76) Inventors: Han-Yu Chao, Taipei County (TW); Chien-Lung Tsou, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 12/358,262

(22) Filed: Jan. 23, 2009

(30) Foreign Application Priority Data
Dec. 10, 2008 (TW) 097147976

(51) Int. Cl. H05B 37/02

(52) U.S. Cl. 315/321

(57) ABSTRACT

A light source system includes a current source for providing a predetermined current, a dimming control switch for turning on/off according to a dimming control signal, a first interlacing-control switch for turning on/off according to a first interlacing-control signal, a second interlacing-control switch for turning on/off according to a second interlacing-control signal, a first light emitting load for emitting light when receiving the predetermined current through the first interlacing-control switch and the dimming switch, and a second light emitting load for emitting light when receiving the predetermined current through the second interlacing-control switch and the dimming switch. When the first interlacing-control switch is turned on, the second interlacing-control switch is turned off. When the second interlacing-control switch is turned on, the first interlacing-control switch is turned off.

### BACKGROUND OF THE INVENTION

1. Field of the Invention

The present invention relates to a light source system, and more particularly, to a light source system with an interlacing-control module for controlling light loads of the light source system interlacingly so as to save required components.

2. Description of the Prior Art

Please refer to FIG. 1. FIG. 1 is a diagram illustrating a conventional light source system 100. The light source system 100 can be applied to a back-light module of a Liquid Crystal Display (LCD) or other similar devices. The light source system 100 comprises a light module 110, a dimming module 120, and a current control module 130.

The light module 110 comprises N Light Emitting Diode (LED) series LED₁˜LED_{N}. Each of the LED series LED₁˜LED_{N} can be composed of M LEDs connected in series. For instance, the LED series LED₁ comprises M LEDs connected in series.

The dimming module comprises N dimming switches SW₁˜SW_{N}. Each of the dimming switches SW₁˜SW_{N} can be realized with an N channel Metal Oxide Semiconductor (NMOS) transistor. Each of the dimming switches SW₁˜SW_{N} is controlled to be turned on/off according to a corresponding dimming signal. For example, the dimming switch SW₁ is turned on or turned off according to the dimming signal S_{DIM1}.

The current control module 130 comprises N constant current sources IS₁˜IS_{N}. Each of the constant current sources IS₁˜IS_{N} provides a same current I₁.

In the light source system 100, each LED series electrically connects to a corresponding constant current source through a corresponding dimming switch. For example, the LED series LED₁ electrically connects to the constant current source IS₁ through the dimming switch SW₁. In this way, when the dimming signal S_{DIM1} controls the dimming switch SW₁ to turn on, the LED series LED₁ emits light according to the current I₁ provided by the constant current source IS₁, and the luminance of the light emitted from the LED series LED₁ is positively related to the magnitude of the current I₁. On the contrary, when the dimming signal S_{DIM1} controls the dimming switch SW₁ to turn off, the LED series LED₁ does not receive the current I₁ provided by the constant current source IS₁ and thus no light is emitted from the LED series LED₁.

The dimming signal may be a Pulse Width Modulation (PWM) signal. That is, the dimming signal may be a periodic signal with a period T_{D}. In a period of the dimming signal, the ratio of the dimming signal being at the high/low voltage level can be adjusted. In other words, the duty ratio of the dimming signal can be adjusted. The light source system 100 controls the duty ratio of each dimming signal respectively for controlling turn-on time of each dimming switch so as to control the average luminance of the light emitted from each LED series. For example, the light source system 100 increases the duty ratio (such as 30%) of the dimming signal S_{DIM1} for increasing the turn-on time of the dimming switch SW₁. In other words, the period of the LED series LED₁ receiving the current I₁ from the constant current source IS₁ is increased. On average, the luminance of the light emitted from the LED series LED₁ is increased (such as L₃). On the contrary, the light source system 100 decreases the duty ratio (such as 10%) of the dimming signal S_{DIM1} for decreasing the turn-on time of the dimming switch SW₁. In other words, the period of the LED series LED₁ receiving the current I₁ from the constant current source IS₁ is decreased. On average, the luminance of the light emitted from the LED series LED₁ is decreased (such as L₁).

Please refer to FIG. 2. FIG. 2 is a timing diagram illustrating signal relation of the light source system 100. In FIG. 2, only the dimming signal S_{DIM1} and the corresponding LED series LED₁ are presented as an example, and the relations of the rest dimming signals and their corresponding LED series are similar. As shown in FIG. 2, the light source system 100 may control the light module 110 and the dimming module 120 with periodic manner, and the period of the light source system 100 is the period T_{F} as shown in FIG. 2. When the light source system 100 is applied to the backlight module of an LCD, the period T_{F} is the duration of the LCD scanning one frame. For example, if the duration of the LCD scanning one frame is 16.6 ms, then the period T_{F} is 16.6 ms as well. However, the period T_{F} of the light source system 100 is not limited to the duration of the LCD scanning one frame, and can be designed as desired. In FIG. 2, when the light source system 100 adjusts the luminance of the LED series LED₁ to be L₁, the duty ratio of the dimming signal S_{DIM1} is adjusted to be 10%; when the light source system 100 adjusts the luminance of the LED series LED₁ to be L₂, the duty ratio of the dimming signal S_{DIM1} is adjusted to be 20%; when the light source system 100 adjusts the luminance of the LED series LED₁ to be L₃, the duty ratio of the dimming signal S_{DIM1} is adjusted to be 30%. Furthermore, the luminance L₃ is three times the luminance L₁; the luminance L₂ is two times the luminance L₁. In this manner, the light source system 100 adjusts the duty ratio of each dimming signal to control the luminance of the light source system.

However, as shown in FIG. 1, each LED series requires a corresponding dimming switch and a corresponding constant current source. In other words, in FIG. 1, N LED series require N dimming switches and N constant current sources. Because of the nature of LED series, the dimming switches and the constant current sources applied have to withstand high voltages and currents. Therefore, the dimming switches and the constant current sources share a very big part of the total cost of the light source system 100, which causes difficulty to apply or manufacture, greatly degenerating the convenience that the light source system 100 can provide.

### SUMMARY OF THE INVENTION

The present invention provides a light source system. The light source system comprises a constant current source for providing a predetermined current, a dimming switch for being turned on or off according to a dimming signal, a first interlacing-control switch for being turned on or off according to a first interlacing-control switch, a second interlacing-control switch for being turned on or off according to a second interlacing-control switch, a first light load for receiving the predetermined current through the first interlacing-control switch and the dimming switch, and a second light load for receiving the predetermined current through the second interlacing-control switch and the dimming switch.

The present invention further provides a light source system. The light source system comprises a constant current source for providing a predetermined current, a dimming switch for being turned on or off according to a dimming signal, a plurality of interlacing-control switches for being turned on or off according to corresponding interlacing-control signals, and a plurality of light loads. Each light load receives the predetermined current through a corresponding one of the plurality of the interlacing-control switches and the dimming switch.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional light source system.

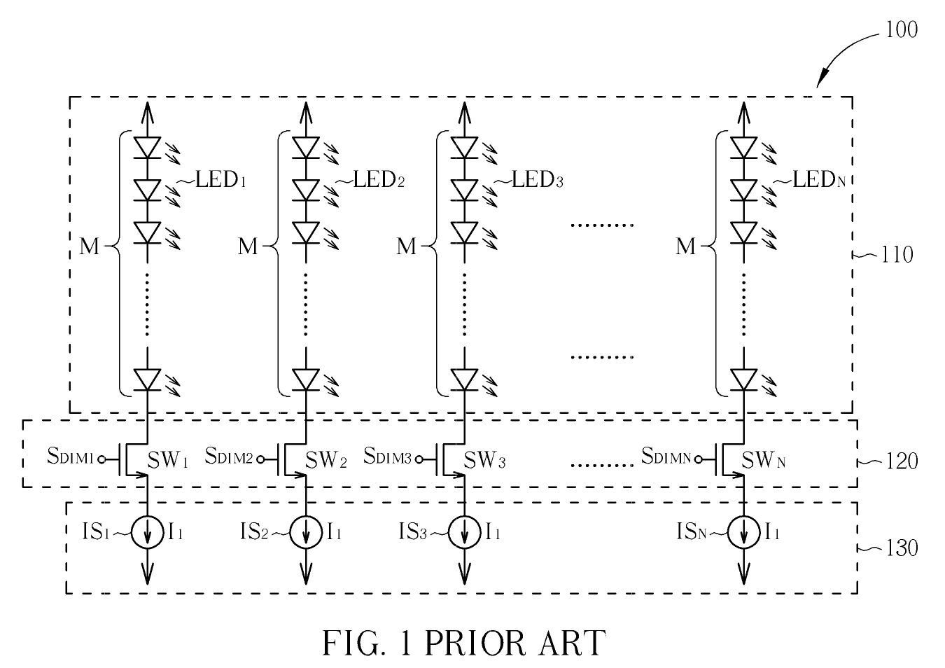

FIG. 2 is a timing diagram illustrating signal relation of the conventional light source system.

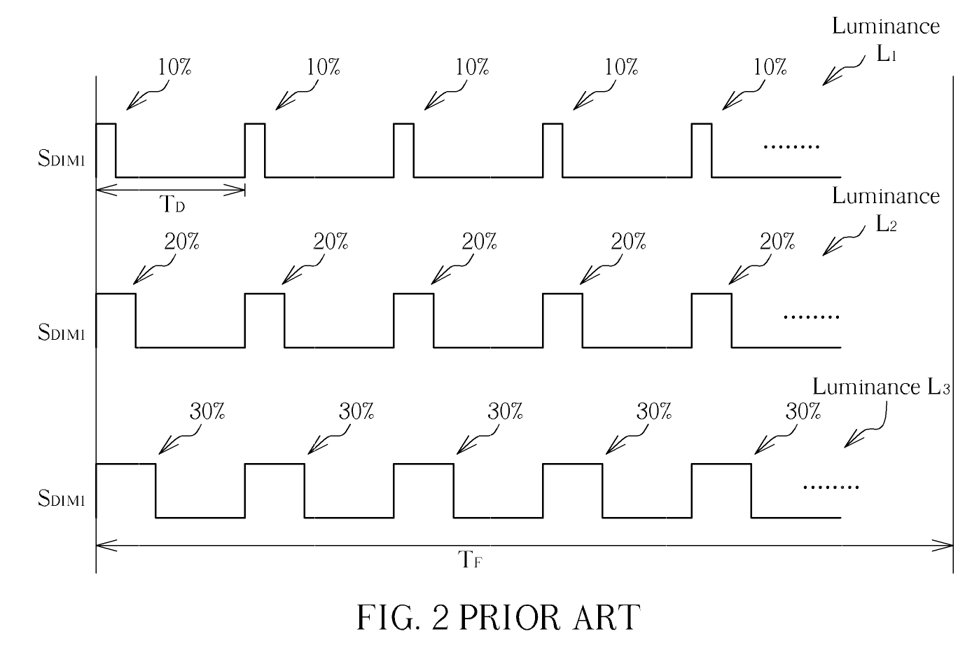

FIG. 3 is a diagram illustrating a light source system according to a first embodiment of the present invention.

FIG. 4 is a timing diagram illustrating the luminance adjustment according to a first embodiment of the light source system of the present invention.

FIG. 5 is a timing diagram illustrating the luminance adjustment according to a second embodiment of the light source system of the present invention.

FIG. 6 is a diagram illustrating a light source system 600 according to a second embodiment of the present invention.

FIG. 7 is a timing diagram illustrating the luminance adjustment according to a first embodiment of the light source system 600 of the present invention.

FIG. 8 is a timing diagram illustrating the luminance adjustment according to a second embodiment of the light source system 600 of the present invention.

FIG. 9 is a diagram illustrating a light source system 900 according to a third embodiment of the present invention.

FIG. 10 is a diagram illustrating a light source system 1000 according to a fourth embodiment of the present invention.

### DETAILED DESCRIPTION

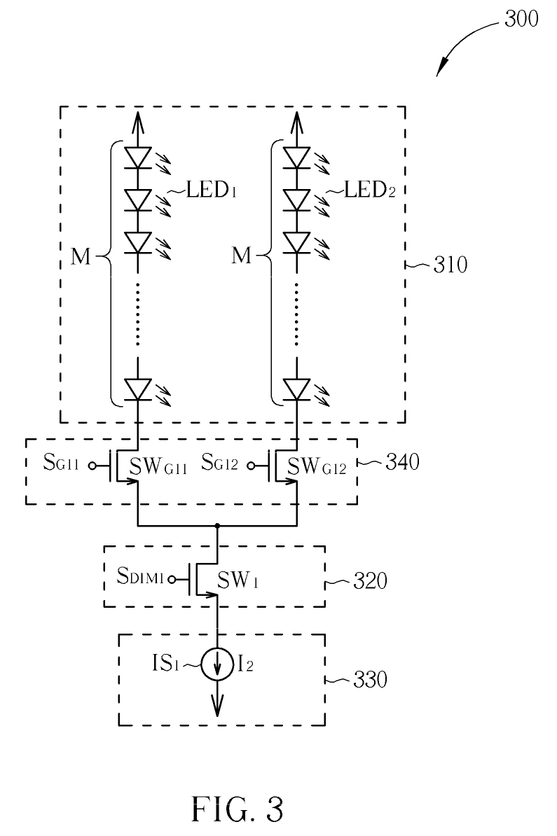

Please refer to FIG. 3. FIG. 3 is a diagram illustrating a light source system 300 according to a first embodiment of the present invention. The light source system 300 can be applied to the backlight module of an LCD or other similar devices. The light source system 300 comprises a light module 310, a dimming module 320, a current control module 330, and an interlacing-control module 340. The design of the interlacing-control module 340 of the light source system 300 saves the number of the requiring components of the dimming modules and the current control modules, which reduces the cost.

The light module 310 comprises two LED series (light load) LED₁ and LED₂. The LED series LED₁ and LED₂ can be respectively composed of M LEDs connected in series. For example, the LED series LED₁ comprises M LEDs connected in series.

The dimming module 320 comprises a dimming switch SW₁. The dimming switch SW₁ can be realized with an N channel Metal Oxide Semiconductor (NMOS) transistor. The dimming switch SW₁ is turned on/off according to the dimming signal S_{DIM1}. The dimming signal may be a PWM signal. That is, the dimming signal may be a periodic signal with a period T_{D}. In a period of the dimming signal S_{DIM1}, the ratio of the dimming signal S_{DIM1} being at the high/low voltage level can be adjusted. In other words, the duty ratio of the dimming signal S_{DIM1} can be adjusted. The light source system 300 controls the duty ratio of the dimming signal S_{DIM1} for controlling the on-time of the dimming switch SW₁ so as to control the average luminance of the LED series LED₁ and LED₂ respectively through the interlacing-control switches SW_{G11} and SW_{G12}.

The current control module 330 comprises a constant current source IS₁. The constant current source IS₁ provides a current I₂.

The interlacing-control module 340 comprises two interlacing-control switches SW_{G11} and SW_{G12}. The interlacing-control switches SW_{G11} and SW_{G12} can be realized with NMOS transistors. The interlacing-control switches SW_{G11} and SW_{G12} are respectively controlled to turn on/off according to the interlacing-control signals S_{G11} and S_{G12}.

The LED series LED₁ is coupled to the interlacing-control switch SW_{G11}; the LED series LED₂ is coupled to the interlacing-control switch SW_{G12}. The interlacing-control switch SW_{G11} is coupled between the LED series LED₁ and the dimming switch SW₁; the interlacing-control switch SW_{G12} is coupled between the LED series LED₂ and the dimming switch SW₁. The dimming switch SW₁ is coupled to the constant current source IS₁, and is coupled to the interlacing-control switches SW_{G11} and SW_{G12}, respectively.

In the light source system 300, each LED series is coupled to a corresponding dimming switch and the constant current source through a corresponding interlacing-control switch. For example, the LED series LED₁ is coupled to the dimming switch SW₁ and the constant current source IS₁ through the interlacing-control switch SW_{G11}. In this way, when the interlacing-control switch SW_{G11} is turned on by the interlacing-control signal S_{G11}, the LED series LED₁ receives the current I₂ provided by the constant current source IS₁ through the dimming switch SW₁ and emits light accordingly. The luminance of the light emitted by the LED series LED₁ is direct proportional to the magnitude of the current I₂, and the average luminance of the light emitted by the LED series LED₁ is also direct proportional to the duty ratio of the dimming signal S_{DIM1}. On the contrary, when the interlacing-control switch SW_{G11} is turned off by the interlacing-control signal S_{G11}, the LED series LED₁ cannot receive the current I₂ provided by the constant current source IS₁ and cannot emit light.

In the interlacing-control module 340, the on-times of the interlacing-control switches SW_{G11} and SW_{G12} are distributed interlacingly. That is, the interlacing-control signals S_{G11} and S_{G12} respectively controlling the on-times of the interlacing-control switches SW_{G11} and SW_{G12} are distributed interlacingly. In other words, when the interlacing-control switch SW_{G11} is turned on, the interlacing-control switch SW_{G12} is turned off; when the interlacing-control switch SW_{G12} is turned on, the interlacing-control switch SW_{G11} is turned off. By such mechanism, the LED series LED₁ and LED₂ are capable of sharing only one dimming switch SW₁ and one constant current source IS₁ through the interlacing-control switches SW_{G11} and SW_{G12}.

When the interlacing-control switch SW_{G11} is turned on, which means the interlacing-control switch SW_{G12} is turned off at meantime, the light source system 300 may increase the duty ratio of the dimming signal S_{DIM1}, e.g. 30%, so that the on-time of the dimming switch SW₁ is increased as well. In other words, the period that the LED series LED₁ receives the current I₂ provided by the constant current source IS₁ is increased. On average, the luminance of the light emitted by the LED series LED₁ may be higher. Meanwhile, since the interlacing-control switch SW_{G12} is turned off, the LED series LED₂ does not emit light at all. On the contrary, the light source system 300 may also decrease the duty ratio of the dimming signal S_{DIM1}, e.g. 10%, so that the on-time of the dimming switch SW₁ is decreased as well. In other words, the period that the LED series LED₁ receives the current I₂ provided by the constant current source IS₁ is decreased. On average, the luminance of the light emitted by the LED series LED₁ may be lower. Meanwhile, since the interlacing-control switch SW_{G12} is turned off, the LED series LED₂ does not emit light at all.

On the other hand, when the interlacing-control switch SW_{G12} is turned on, which means the interlacing-control switch SW_{G11} is turned off at meantime, the light source system 300 may increase the duty ratio of the dimming signal S_{DIM1}, e.g. 30%, so that the on-time of the dimming switch SW₁ is increased as well. In other words, the period that the LED series LED₂ receives the current I₂ provided by the constant current source IS₁ is increased. On average, the luminance of the light emitted by the LED series LED₂ may be higher. Meanwhile, since the interlacing-control switch SW_{G11} is turned off, the LED series LED₁ does not emit light at all. On the contrary, the light source system 300 may also decrease the duty ratio of the dimming signal S_{DIM1}, e.g. 10%, so that the on-time of the dimming switch SW₁ is decreased as well. In other words, the period that the LED series LED₂ receives the current I₂ provided by the constant current source IS₁ is decreased. On average, the luminance of the light emitted by the LED series LED₂ may be lower. Meanwhile, since the interlacing-control switch SW_{G11} is turned off, the LED series LED₁ does not emit light at all.

As described above, the light source system 300 provides dimming signal S_{DIM1} with different duty ratios during the on-times of the interlacing-control switches SW_{G11} and SW_{G12}, respectively. In this way, although the LED series LED₁ and LED₂ share only one dimming switch SW₁ and one constant current source IS₁, the LED series LED₁ can still emit light with the luminance different from that of the LED series LED₂. For example, when the interlacing-control switch SW_{G11} is turned on (the interlacing-control switch SW_{G12} is turned off), the light source system 300 may provide the dimming signal S_{DIM1} with the duty ratio 30%, in order to allow the LED series LED₁ to emit light with higher average luminance, and meanwhile, LED series LED₂ does not emit light at all; when the interlacing-control switch SW_{G12} is turned on (the interlacing-control switch SW_{G11} is turned off), the light source system 300 may provide the dimming signal S_{DIM1} with the duty ratio 10%, in order to allow the LED series LED₂ to emit light with lower average luminance, and meanwhile, the LED series LED₁ does not emit light at all.

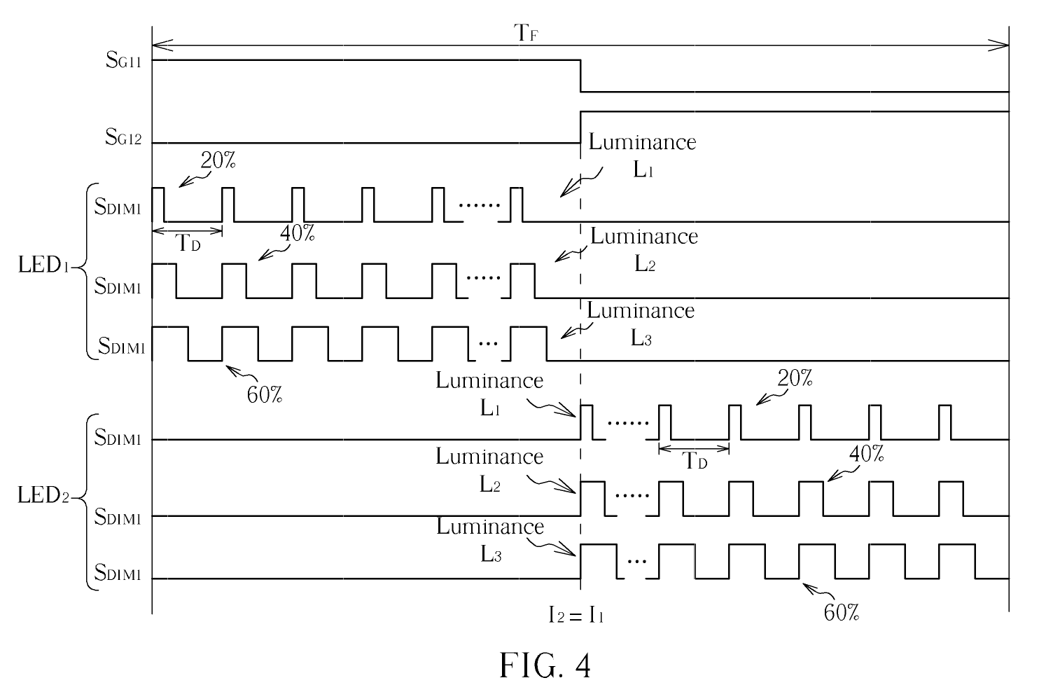

Please refer to FIG. 4. FIG. 4 is a timing diagram illustrating the luminance adjustment according to a first embodiment of the light source system 300 of the present invention. As shown in FIG. 4, the light source system 300 is capable of periodically controlling the light module 310 and the dimming module 320, and the period of the light source system 300 is the period T_{F} as shown in FIG. 4. When the light source system 300 is applied to the backlight module of an LCD, the period T_{F} is the duration of a frame. For example, if the LCD scans a frame for 16.6 ms, the period T_{F} may be 16.6 ms. However, the period T_{F} of the light source system 300 is not limited to the duration of one frame and can be changed as desired. In FIG. 4, the current I₂ provided by the constant current source IS₁ has the same magnitude as the current I₁ provided by the conventional light source system 100. From FIG. 4, it is seen that each of the on-times of the interlacing-control switches SW_{G11} and SW_{G12} respectively controlled by the interlacing-control signals S_{G11} and S_{G12} occupies half of the period T_{F}. That is, the interlacing-control signal S_{G11} controls the interlacing-control switch SW_{G11} to turn on during the first half period of the period T_{F}, e.g. 16.6 ms/2=8.3 ms, and the interlacing-control signal S_{G12} controls the interlacing-control switch SW_{G12} to turn on during the second half period of the period T_{F}, e.g. 16.6 ms/2=8.3 ms. For the LED series LED₁ and LED₂, the actual period that the LED series LED₁ and LED₂ emit light according to the dimming signal S_{DIM1} is only a half of the entire period T_{F}. Under such conduction, if the LED series LED₁ is required to emit light with average luminance L₁, the light source system 300 may double the duty ratio (from the original 10% to 20%), so that in the entire period T_{F}, the average luminance of the light emitted by the LED series LED₁ will be L₁. Similarly, under such conduction, if the LED series LED₁ is required to emit light with average luminance L₂, the light source system 300 may double the duty ratio (from the original 20% to 40%), so that in the entire period T_{F}, the average luminance of the light emitted by the LED series LED₁ will be L₂. Furthermore, if the LED series LED₁ is required to emit light with average luminance L₃, the light source system 300 may double the duty ratio (from the original 30% to 60%), so that in the entire period T_{F}, the average luminance of the light emitted by the LED series LED₁ will be L₃. For the LED series LED₂, the operation principle is similar as above and will not be repeated for brevity. The following is an example of the light source system 300 controlling the LED series LED₁ and LED₂ to emit light with different luminance. If the LED series LED₁ is required to emit light with the average luminance L₁ during the entire period T_{F}, and the LED series LED₂ is required to emit light with the average luminance L₃ during the entire period T_{F}, the light source system 300 has to set the duty ratio of the dimming signal to be 20% during the first half of the period T_{F} and to be 60% during the second half of the period T_{F}, so that during the entire period T_{F}, the average luminance of the LED series LED₁ will be L₁ and the average luminance of the LED series LED₂ will be L₃. Besides, the luminance L₃ is three times the luminance L₁, and the luminance L₂ is two times the luminance L₁. In this way, the light source system 300 can adjust the duty ratio of the dimming signal by time-dividing manner in order to control the average luminance of each LED series respectively.

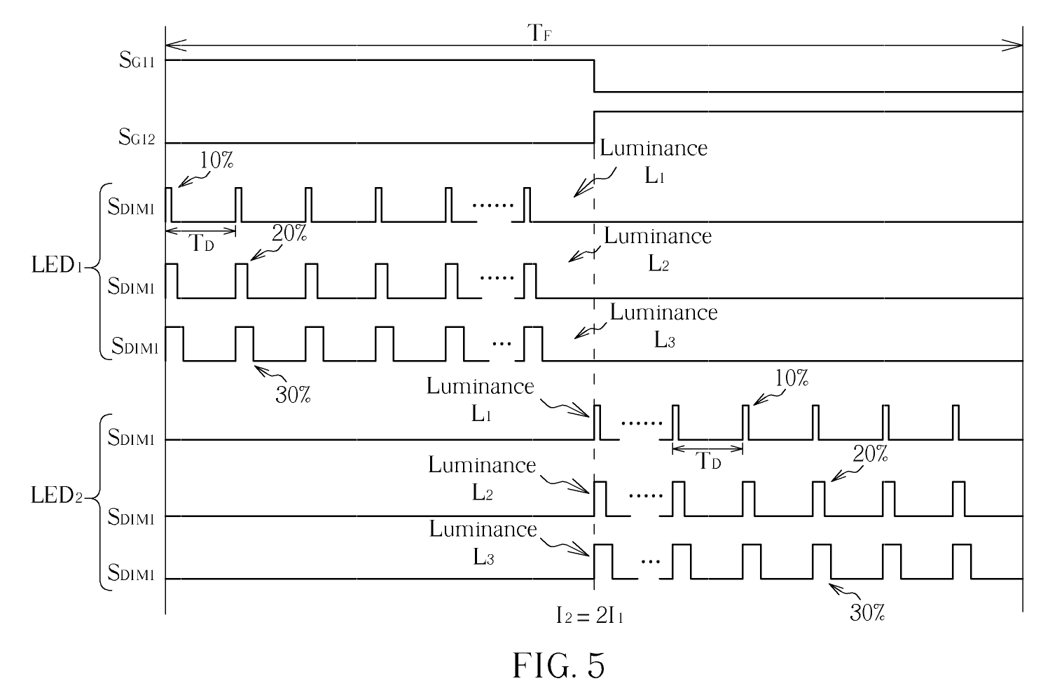

Please refer to FIG. 5. FIG. 5 is a timing diagram illustrating the luminance adjustment according to a second embodiment of the light source system 300 of the present invention. As shown in FIG. 5, the light source system 300 is capable of periodically controlling the light module 310 and the dimming module 320, and the period of the light source system 300 is the period T_{F} as shown in FIG. 5. When the light source system 300 is applied to the backlight module of an LCD, the period T_{F} is the duration of a frame. For example, if the LCD scans a frame for 16.6 ms, the period T_{F} may be 16.6 ms. However, the period T_{F} of the light source system 300 is not limited to the duration of one frame and can be changed as desired. From FIG. 5, it is seen that each of the on-times of the interlacing-control switches SW_{G11} and SW_{G12} respectively controlled by the interlacing-control signals S_{G11} and S_{G12} occupies half of the period T_{F}. That is, the interlacing-control signal S_{G11} controls the interlacing-control switch SW_{G11} to turn on during the first half period of the period T_{F}, e.g. 16.6 ms/2=8.3 ms, and the interlacing-control signal S_{G12} controls the interlacing-control switch SW_{G12} to turn on during the second half period of the period T_{F}, e.g. 16.6 ms/2=8.3 ms. For the LED series LED₁ and LED₂, the actual period that the LED series LED₁ and LED₂ emit light according to the dimming signal S_{DIM1} is only a half of the entire period T_{F}. Under such conduction, if the LED series LED₁ is required to emit light with average luminance L₁, the light source system 300 may increase the magnitude of the current I₂ provided by the constant current source IS₁ to the double of the current I₁ provided by the conventional light source system 100, which means I₂=2I₁, and the duty ratio of the dimming signal S_{DIM1} is still 10% as the same as the duty ratio of the dimming signal of the conventional light source system 100, so that in the entire period T_{F}, the average luminance of the light emitted by the LED series LED₁ will be L₁. Similarly, under such conduction, if the LED series LED₁ is required to emit light with average luminance L₂, the light source system 300 may increase the magnitude of the current I₂ provided by the constant current source IS₁ to the double of the current I₁ provided by the conventional light source system 100, which means I₂=2I₁, and the duty ratio of the dimming signal S_{DIM1} is still 20% as the same as the duty ratio of the dimming signal of the conventional light source system 100, so that in the entire period T_{F}, the average luminance of the light emitted by the LED series LED₁ will be L₂. Furthermore, if the LED series LED₁ is required to emit light with average luminance L₃, the light source system 300 may increase the magnitude of the current I₂ provided by the constant current source IS₁ to the double of the current I₁ provided by the conventional light source system 100, which means I₂=2I₁, and the duty ratio of the dimming signal S_{DIM1} is still 30% as the same as the duty ratio of the dimming signal of the conventional light source system 100, so that in the entire period T_{F}, the average luminance of the light emitted by the LED series LED₁ will be L₃. For the LED series LED₂, the operation principle is similar as above and will not be repeated for brevity. The following is an example of the light source system 300 controlling the LED series LED₁ and LED₂ to emit light with different luminance. If the LED series LED₁ is required to emit light with the average luminance L₁ during the entire period T_{F}, and the LED series LED₂ is required to emit light with the average luminance L₃ during the entire period T_{F}, the light source system 300 has to set the duty ratio of the dimming signal to be 10% during the first half of the period T_{F} and to be 30% during the second half of the period T_{F} and set the magnitude of the current I₂ to be double the current I₁, so that during the entire period T_{F}, the average luminance of the LED series LED₁ will be L₁ and the average luminance of the LED series LED₂ will be L₃. Besides, the luminance L₃ is three times the luminance L₁, and the luminance L₂ is two times the luminance L₁. In this way, the light source system can increase the current provided by the constant current source and adjust the duty ratio of the dimming signal by time-dividing manner in order to control the average luminance of each LED series respectively.

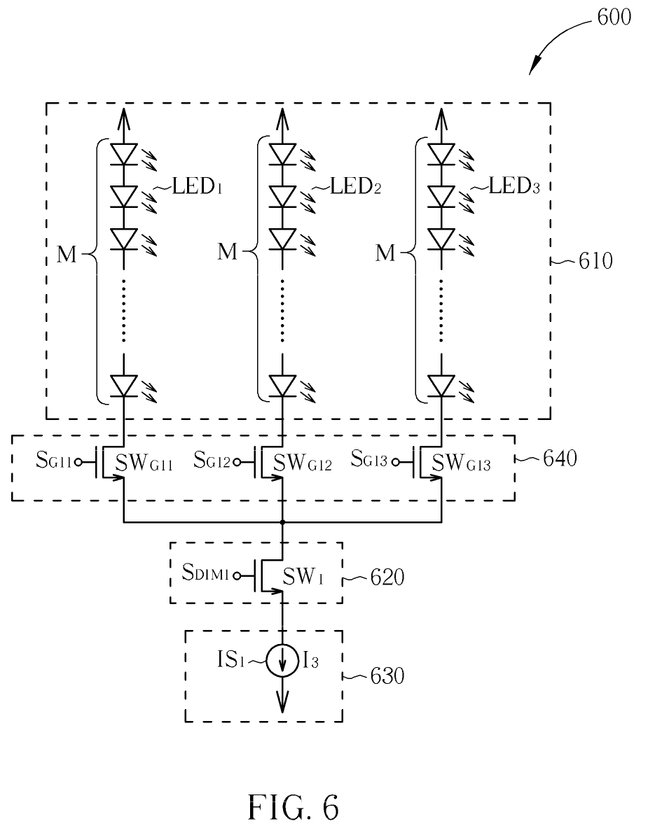

Please refer to FIG. 6. FIG. 6 is a diagram illustrating a light source system 600 according to a second embodiment of the present invention. The light source system 600 can be applied to the backlight module of an LCD or other similar devices. The light source system 600 comprises a light module 610, a dimming module 620, a current control module 630, and an interlacing-control module 640. The design of the interlacing-control module 640 of the light source system 600 saves the number of the requiring components of the dimming modules and the current control modules, which reduces the cost.

The light module 610 comprises three LED series (light load) LED₁, LED₂, and LED₃. The LED series LED₁, LED₂, and LED₃ can be respectively composed of M LEDs connected in series. For example, the LED series LED₁ comprises M LEDs connected in series.

The dimming module 620 comprises a dimming switch SW₁. The dimming switch SW₁ can be realized with an NMOS transistor. The dimming switch SW₁ is turned on/off according to the dimming signal S_{DIM1}. The dimming signal may be a PWM signal. That is, the dimming signal may be a periodic signal with a period T_{D}. In a period of the dimming signal S_{DIM1}, the ratio of the dimming signal S_{DIM1} being at the high/low voltage level can be adjusted. In other words, the duty ratio of the dimming signal S_{DIM1} can be adjusted. The light source system 600 controls the duty ratio of the dimming signal S_{DIM1} for controlling the on-time of the dimming switch SW₁ so as to control the average luminance of the LED series LED₁, LED₂, and LED₃ respectively through the interlacing-control switches SW_{G11}, SW_{G12}, and SW_{G13}.

The current control module 630 comprises a constant current source IS₁. The constant current source IS₁ provides a current I₃.

The interlacing-control module 640 comprises three interlacing-control switches SW_{G11}, SW_{G12}, and SW_{G13}. The interlacing-control switches SW_{G11}, SW_{G12}, and SW_{G13} can be realized with NMOS transistors. The interlacing-control switches SW_{G11}, SW_{G12}, and SW_{G13} are respectively controlled to turn on/off according to the interlacing-control signals S_{G11}, S_{G12}, and S_{G13}.

The LED series LED₁ is coupled to the interlacing-control switch SW_{G11}; the LED series LED₂ is coupled to the interlacing-control switch SW_{G12}; the LED series LED₃ is coupled to the interlacing-control switch SW_{G13}. The interlacing-control switch SW_{G11} is coupled between the LED series LED₁ and the dimming switch SW₁; the interlacing-control switch SW_{G12} is coupled between the LED series LED₂ and the dimming switch SW₁; the interlacing-control switch SW_{G13} is coupled between the LED series LED₃ and the dimming switch SW₁. The dimming switch SW₁ is coupled to the constant current source IS₁, and is coupled to the interlacing-control switches SW_{G11}, SW_{G12}, and SW_{G13}, respectively.

In the light source system 600, each LED series is coupled to a corresponding dimming switch and the constant current source through a corresponding interlacing-control switch. For example, the LED series LED₁ is coupled to the dimming switch SW₁ and the constant current source IS₁ through the interlacing-control switch SW_{G11}. In this way, when the interlacing-control switch SW_{G11} is turned on by the interlacing-control signal S_{G11}, the LED series LED₁ receives the current I₃ provided by the constant current source IS₁ through the dimming switch SW₁ and emits light accordingly. The luminance of the light emitted by the LED series LED₁ is direct proportional to the magnitude of the current I₃, and the average luminance of the light emitted by the LED series LED₁ is also direct proportional to the duty ratio of the dimming signal S_{DIM1}. On the contrary, when the interlacing-control switch SW_{G11} is turned off by the interlacing-control signal S_{G11}, the LED series LED₁ cannot receive the current I₃ provided by the constant current source IS₁ and cannot emit light.

In the interlacing-control module 640, the on-times of the interlacing-control switches SW_{G11}, SW_{G12}, and SW_{G13} are distributed interlacingly. That is, the interlacing-control signals S_{G11}, S_{G12}, and S_{G13} respectively controlling the on-times of the interlacing-control switches SW_{G11}, SW_{G12}, and SW_{G13} are distributed interlacingly. In other words, when the interlacing-control switch SW_{G11} is turned on, the interlacing-control switches SW_{G12} and SW_{G13} are turned off; when the interlacing-control switch SW_{G12} is turned on, the interlacing-control switches SW_{G11} and SW_{G13} are turned off; when the interlacing-control switch SW_{G13} is turned on, the interlacing-control switches SW_{G11} and SW_{G12} are turned off. By such mechanism, the LED series LED₁, LED₂, and LED₃ are capable of sharing only one dimming switch SW₁ and one constant current source IS₁ through the interlacing-control switches SW_{G11}, SW_{G12}, and SW_{G13}.

When the interlacing-control switch SW_{G11} is turned on, which means the interlacing-control switches SW_{G12} and SW_{G13} are turned off at meantime, the light source system 600 may increase the duty ratio of the dimming signal S_{DIM1}, e.g. 30%, so that the on-time of the dimming switch SW₁ is increased as well. In other words, the period that the LED series LED₁ receives the current I₃ provided by the constant current source IS₁ is increased. On average, the luminance of the light emitted by the LED series LED₁ may be higher. Meanwhile, since the interlacing-control switches SW_{G12} and SW_{G13} are turned off, the LED series LED₂ and LED₃ do not emit light at all. On the contrary, the light source system 600 may also decrease the duty ratio of the dimming signal S_{DIM1}, e.g. 10%, so that the on-time of the dimming switch SW₁ is decreased as well. In other words, the period that the LED series LED₁ receives the current I₃ provided by the constant current source IS₁ is decreased. On average, the luminance of the light emitted by the LED series LED₁ may be lower. Meanwhile, since the interlacing-control switches SW_{G12} and SW_{G13} are turned off, the LED series LED₂ and LED₃ do not emit light at all.

On another aspect, when the interlacing-control switch SW_{G12} is turned on, which means the interlacing-control switches SW_{G11} and SW_{G13} are turned off at meantime, the light source system 600 may increase the duty ratio of the dimming signal S_{DIM1}, e.g. 30%, so that the on-time of the dimming switch SW₁ is increased as well. In other words, the period that the LED series LED₂ receives the current I₃ provided by the constant current source IS₁ is increased. On average, the luminance of the light emitted by the LED series LED₂ may be higher. Meanwhile, since the interlacing-control switches SW_{G11} and SW_{G13} are turned off, the LED series LED₁ and LED₃ do not emit light at all. On the contrary, the light source system 600 may also decrease the duty ratio of the dimming signal S_{DIM1}, e.g. 10%, so that the on-time of the dimming switch SW₁ is decreased as well. In other words, the period that the LED series LED₂ receives the current 13 provided by the constant current source IS₁ is decreased. On average, the luminance of the light emitted by the LED series LED₂ may be lower. Meanwhile, since the interlacing-control switches SW_{G11} and SW_{G13} are turned off, the LED series LED₁ and LED₃ do not emit light at all.

On another aspect, when the interlacing-control switch SW_{G13} is turned on, which means the interlacing-control switches SW_{G11} and SW_{G12} are turned off at meantime, the light source system 600 may increase the duty ratio of the dimming signal S_{DIM1}, e.g. 30%, so that the on-time of the dimming switch SW₁ is increased as well. In other words, the period that the LED series LED₃ receives the current I₃ provided by the constant current source IS₁ is increased. On average, the luminance of the light emitted by the LED series LED₃ may be higher. Meanwhile, since the interlacing-control switches SW_{G11} and SW_{G12} are turned off, the LED series LED₁ and LED₂ do not emit light at all. On the contrary, the light source system 600 may also decrease the duty ratio of the dimming signal S_{DIM1}, e.g. 10%, so that the on-time of the dimming switch SW₁ is decreased as well. In other words, the period that the LED series LED₃ receives the current I₃ provided by the constant current source IS₁ is decreased. On average, the luminance of the light emitted by the LED series LED₃ may be lower. Meanwhile, since the interlacing-control switches SW_{G11} and SW_{G12} are turned off, the LED series LED₁ and LED₂ do not emit light at all.

As described above, the light source system 600 provides dimming signal S_{DIM1} with different duty ratios during the on-times of the interlacing-control switches SW_{G11}, SW_{G12}, and SW_{G13}, respectively. In this way, although the LED series LED₁, LED₂, and LED₃ share only one dimming switch SW₁ and one constant current source IS₁, the LED series LED₁, LED₂, and LED₃ can still emit light with different luminance. For example, when the interlacing-control switch SW_{G11} is turned on (the interlacing-control switches SW_{G12} and SW_{G13} are turned off), the light source system 600 may provide the dimming signal S_{DIM1} with the duty ratio 30%, in order to allow the LED series LED₁ to emit light with higher average luminance, and meanwhile, LED series LED₂ and LED₃ do not emit light at all; when the interlacing-control switch SW_{G12} is turned on (the interlacing-control switches SW_{G11} and SW_{G13} are turned off), the light source system 600 may provide the dimming signal S_{DIM1} with the duty ratio 10%, in order to allow the LED series LED₂ to emit light with lower average luminance, and meanwhile, the LED series LED₁ and LED₃ do not emit light at all; when the interlacing-control switch SW_{G13} is turned on (the interlacing-control switches SW_{G11} and SW_{G12} are turned off), the light source system 600 may provide the dimming signal S_{DIM1} with the duty ratio 20%, in order to allow the LED series LED₂ to emit light with middle average luminance, and meanwhile, the LED series LED₁ and LED₂ do not emit light at all.

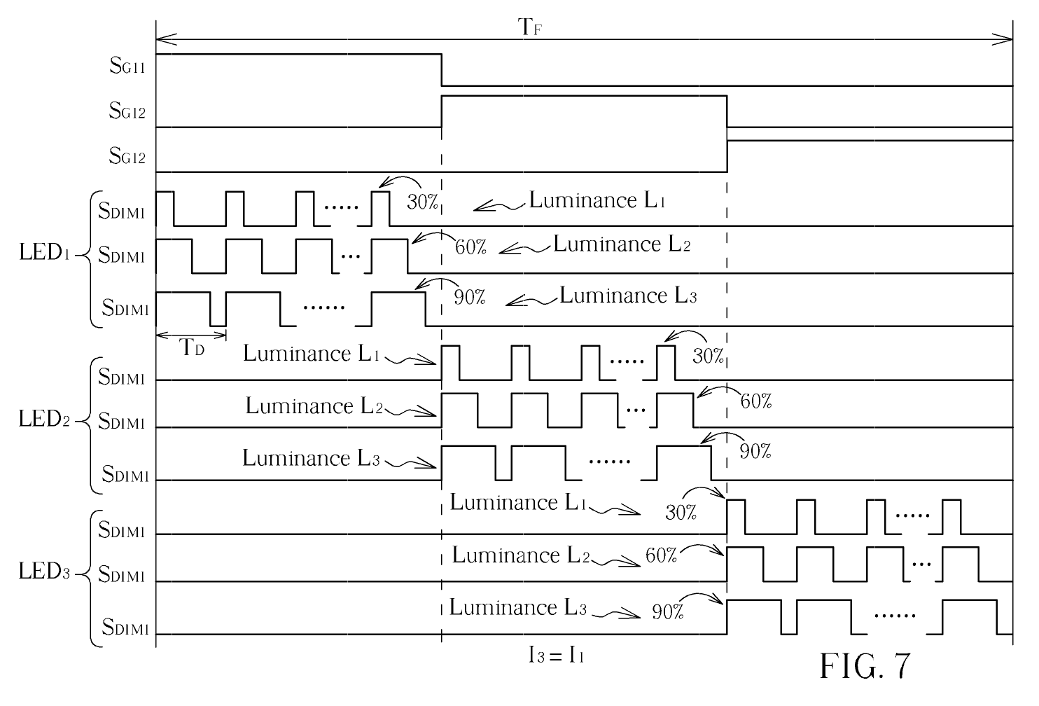

Please refer to FIG. 7. FIG. 7 is a timing diagram illustrating the luminance adjustment according to a first embodiment of the light source system 600 of the present invention. As shown in FIG. 7, the light source system 600 is capable of periodically controlling the light module 610 and the dimming module 620, and the period of the light source system 600 is the period T_{F} as shown in FIG. 7. When the light source system 600 is applied to the backlight module of an LCD, the period T_{F} is the duration of a frame. For example, if the LCD scans a frame for 16.6 ms, the period T_{F} may be 16.6 ms. However, the period T_{F} of the light source system 600 is not limited to the duration of one frame and can be changed as desired. In FIG. 7, the current I₃ provided by the constant current source IS₁ has the same magnitude as the current I₁ provided by the conventional light source system 100. From FIG. 7, it is seen that each of the on-times of the interlacing-control switches SW_{G11}, SW_{G12}, and SW_{G13} respectively controlled by the interlacing-control signals S_{G11}, S_{G12}, and S_{G13} occupies one-third of the period T_{F}. That is, the interlacing-control signal S_{G11} controls the interlacing-control switch SW_{G11} to turn on during the first one-third period of the period T_{F}, e.g. 16.6 ms/3=5.5 ms, the interlacing-control signal S_{G12} controls the interlacing-control switch SW_{G12} to turn on during the second one-third period of the period T_{F}, e.g. 16.6 ms/3=5.5 ms, and the interlacing-control signal S_{G13} controls the interlacing-control switch SW_{G13} to turn on during the last one-third period of the period T_{F}, e.g. 16.6 ms/3=5.5 ms. For the LED series LED₁, LED₂, and LED₃, the actual period that the LED series LED₁, LED₂, and LED₃ emit light according to the dimming signal S_{DIM1} is only one-third of the entire period T_{F}. Under such conduction, if the LED series LED₁ is required to emit light with average luminance L₁, the light source system 600 may triple the duty ratio (from the original 10% to 30%), so that in the entire period T_{F}, the average luminance of the light emitted by the LED series LED₁ will be L₁. Similarly, under such conduction, if the LED series LED₁ is required to emit light with average luminance L₂, the light source system 600 may double the duty ratio (from the original 20% to 60%), so that in the entire period T_{F}, the average luminance of the light emitted by the LED series LED₁ will be L₂. Furthermore, if the LED series LED₁ is required to emit light with average luminance L₃, the light source system 600 may triple the duty ratio (from the original 30% to 90%), so that in the entire period T_{F}, the average luminance of the light emitted by the LED series LED₁ will be L₃. For the LED series LED₂ and LED₃, the operation principle is similar as above and will not be repeated for brevity. The following is an example of the light source system 600 controlling the LED series LED₁, LED₂, and LED₃ to emit light with different luminance. If the LED series LED₁ is required to emit light with the average luminance L₁ during the entire period T_{F}, the LED series LED₂ is required to emit light with the average luminance L₃ during the entire period T_{F}, and the LED series LED₃ is required to emit light with the average luminance L₂ during the entire period T_{F}, the light source system 600 has to set the duty ratio of the dimming signal to be 30% during the first one-third of the period T_{F}, to be 90% during the second one-third of the period T_{F}, and to be 60% during the last one-third of the period T_{F}, so that during the entire period T_{F}, the average luminance of the LED series LED₁ will be L₁, the average luminance of the LED series LED₂ will be L₃, and the average luminance of the LED series LED₃ will be L₂. Besides, the luminance L₃ is three times the luminance L₁, and the luminance L₂ is two times the luminance L₁. In this way, the light source system 600 can adjust the duty ratio of the dimming signal by time-dividing manner in order to control the average luminance of each LED series respectively.

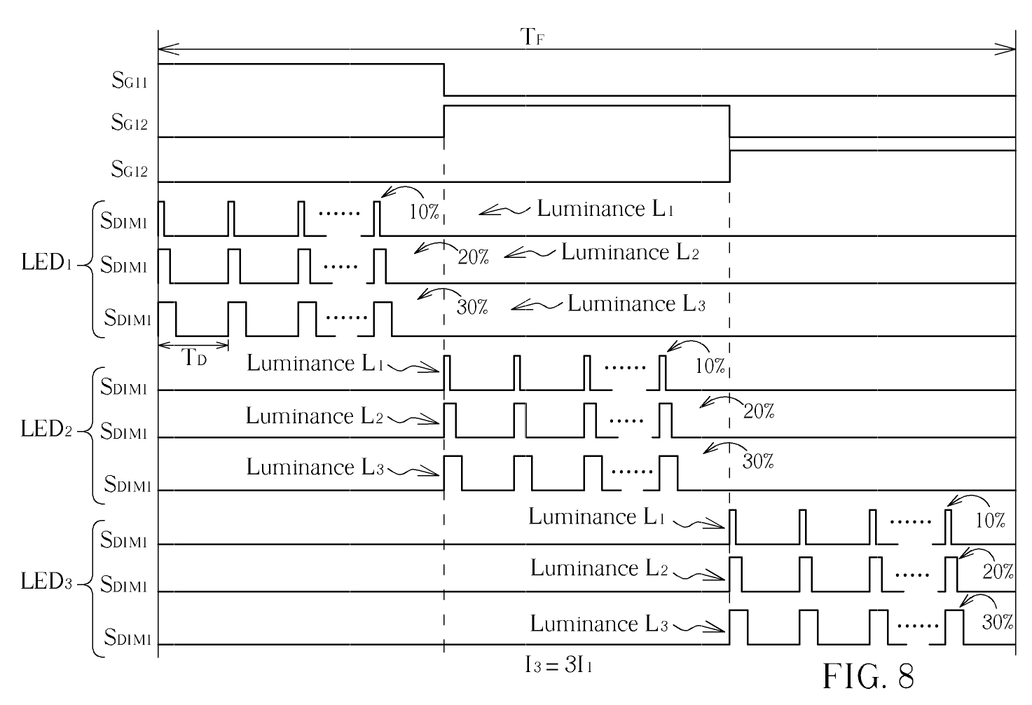

Please refer to FIG. 8. FIG. 8 is a timing diagram illustrating the luminance adjustment according to a second embodiment of the light source system 600 of the present invention. As shown in FIG. 8, the light source system 600 is capable of periodically controlling the light module 610 and the dimming module 620, and the period of the light source system 600 is the period T_{F} as shown in FIG. 8. When the light source system 600 is applied to the backlight module of an LCD, the period T_{F} is the duration of a frame. For example, if the LCD scans a frame for 16.6 ms, the period T_{F} may be 16.6 ms. However, the period T_{F} of the light source system 600 is not limited to the duration of one frame and can be changed as desired. From FIG. 8, it is seen that each of the on-times of the interlacing-control switches SW_{G11}, SW_{G12}, and SW_{G13} respectively controlled by the interlacing-control signals S_{G11}, S_{G12}, and S_{G13} occupies one-third of the period T_{F}. That is, the interlacing-control signal S_{G11} controls the interlacing-control switch SW_{G11} to turn on during the first one-third period of the period T_{F}, e.g. 16.6 ms/3=5.5 ms, the interlacing-control signal S_{G12} controls the interlacing-control switch SW_{G12} to turn on during the second one-third period of the period T_{F}, e.g. 16.6 ms/3=5.5 ms, and the interlacing-control signal S_{G13} controls the interlacing-control switch SW_{G11} to turn on during the last one-third period of the period T_{F}, e.g. 16.6 ms/3=5.5 ms. For the LED series LED₁, LED₂, and LED₃, the actual period that the LED series LED₁, LED₂, and LED₃ emit light according to the dimming signal S_{DIM1} is only one-third of the entire period T_{F}. Under such conduction, if the LED series LED₁ is required to emit light with average luminance L₁, the light source system 600 may increase the magnitude of the current I₃ provided by the constant current source IS₁ to the triple of the current I₁ provided by the conventional light source system 100, which means I₃=3I₁, and the duty ratio of the dimming signal S_{DIM1} is still 10% as the same as the duty ratio of the dimming signal of the conventional light source system 100, so that in the entire period T_{F}, the average luminance of the light emitted by the LED series LED₁ will be L₁. Similarly, under such conduction, if the LED series LED₁ is required to emit light with average luminance L₂, the light source system 600 may increase the magnitude of the current I₃ provided by the constant current source IS₁ to the triple of the current I₁ provided by the conventional light source system 100, which means I₃=3I₁, and the duty ratio of the dimming signal S_{DIM1} is still 20% as the same as the duty ratio of the dimming signal of the conventional light source system 100, so that in the entire period T_{F}, the average luminance of the light emitted by the LED series LED₁ will be L₂. Furthermore, if the LED series LED₁ is required to emit light with average luminance L₃, the light source system 600 may increase the magnitude of the current I₃ provided by the constant current source IS₁ to the triple of the current I₁ provided by the conventional light source system 100, which means I₃=3I₁, and the duty ratio of the dimming signal S_{DIM1} is still 30% as the same as the duty ratio of the dimming signal of the conventional light source system 100, so that in the entire period T_{F}, the average luminance of the light emitted by the LED series LED₁ will be L₃. For the LED series LED₂ and LED₃, the operation principle is similar as above and will not be repeated for brevity. The following is an example of the light source system 600 controlling the LED series LED₁, LED₂, and LED₃ to emit light with different luminance. If the LED series LED₁ is required to emit light with the average luminance L₁ during the entire period T_{F}, the LED series LED₂ is required to emit light with the average luminance L₃ during the entire period T_{F}, and the LED series LED₃ is required to emit light with the average luminance L₂ during the entire period T_{F}, the light source system 600 has to set the duty ratio of the dimming signal to be 10% during the first one-third of the period T_{F}, to be 30% during the second one-third of the period T_{F}, to be 20% during the last one-third of the period T_{F}, and set the magnitude of the current I₃ to be triple the current I₁, so that during the entire period T_{F}, the average luminance of the LED series LED₁ will be L₁, the average luminance of the LED series LED₂ will be L₃, and the average luminance of the LED series LED₃ will be L₂. Besides, the luminance L₃ is three times the luminance L₁, and the luminance L₂ is two times the luminance L₁. In this way, the light source system 600 can increase the current provided by the constant current source and adjust the duty ratio of the dimming signal by time-dividing manner in order to control the average luminance of each LED series respectively.

According to the spirit of the first and the second embodiments of the present invention, it can be derived that a plurality of LED series can share one dimming switch and one constant current source through the interlacing-control module, and the number of the LED series is not limited to two or three. For example, according to the spirit of the first and the second embodiments of the present invention, eight LED series are coupled to one dimming switch and one constant current module respectively through the corresponding interlacing-control switches. Compared to the prior art, the light source system described above, only needs one dimming switch and one constant current source, instead of eight dimming switches and eight constant current sources, which saves the number of the dimming switches and the constant current sources certainly and saves the cost for manufacturing as well. However, it is noticeable that in the example presented above, only one interlacing-control switch is turned on at the time and the rest interlacing-control switches have to be turned off; the sequence for turning on the interlacing-control switches can be designed as desired.

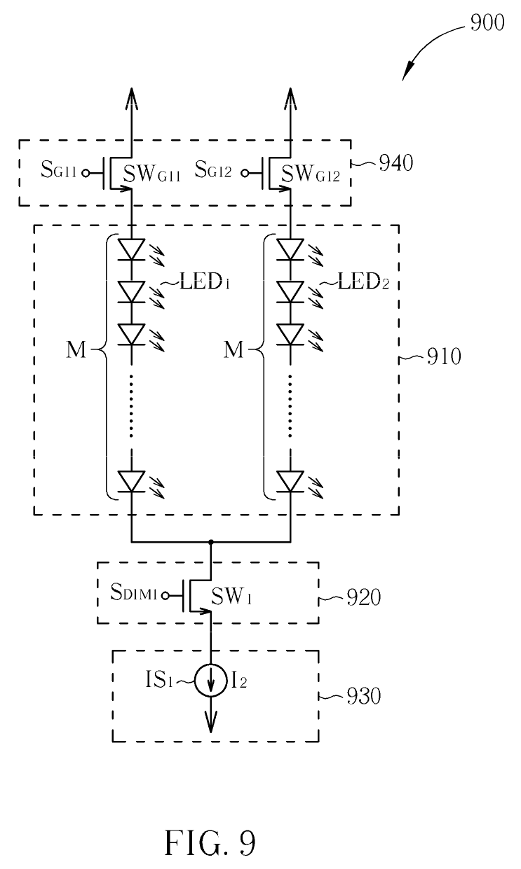

Please refer to FIG. 9. FIG. 9 is a diagram illustrating a light source system 900 according to a third embodiment of the present invention. The light source system 900 can be applied to the backlight module of an LCD or other similar devices. The light source system 900 comprises a light module 910, a dimming module 920, a current control module 930, and an interlacing-control module 940. The design of the interlacing-control module 940 of the light source system 900 saves the number of the requiring components of the dimming module 920 and the current control module 930, which reduces the cost.

In the light source system 900, only the interlacing-control module 940 is different than the interlacing-control module of the light source system 300, and other devices are similar and function the same. Therefore, the related description will not be repeated again for brevity.

The interlacing-control module 940 comprises two interlacing-control switches SW_{G11} and SW_{G12}. The interlacing-control switches SW_{G11} and SW_{G12} can be realized with P-channel Metal Oxide Semiconductor (PMOS) transistors. The interlacing-control switches SW_{G11} and SW_{G12} are turned on/off according to the interlacing-control signals S_{G11} and S_{G12}, respectively.

One end of the LED series LED₁ is coupled to the power source through the interlacing-control switch SW_{G11}; the other end of the LED series LED₁ is coupled to the dimming switch SW₁. One end of the LED series LED₂ is coupled to the power source through the interlacing-control switch SW_{G12}; the other end of the LED series LED₂ is coupled to the dimming switch SW₁. The interlacing-control switch SW_{G11} is coupled between the LED series LED₁ and the power source; the interlacing-control switch SW_{G12} is coupled between the LED series LED₂ and the power source. The dimming switch SW₁ is coupled to the constant current source IS₁; the dimming switch SW₁ is further coupled to the LED series LED₁ and LED₂. By such manner, the light source system 900 saves number of components required by the dimming module 920 and the current control module for reducing cost, which is similar to the light source system 300.

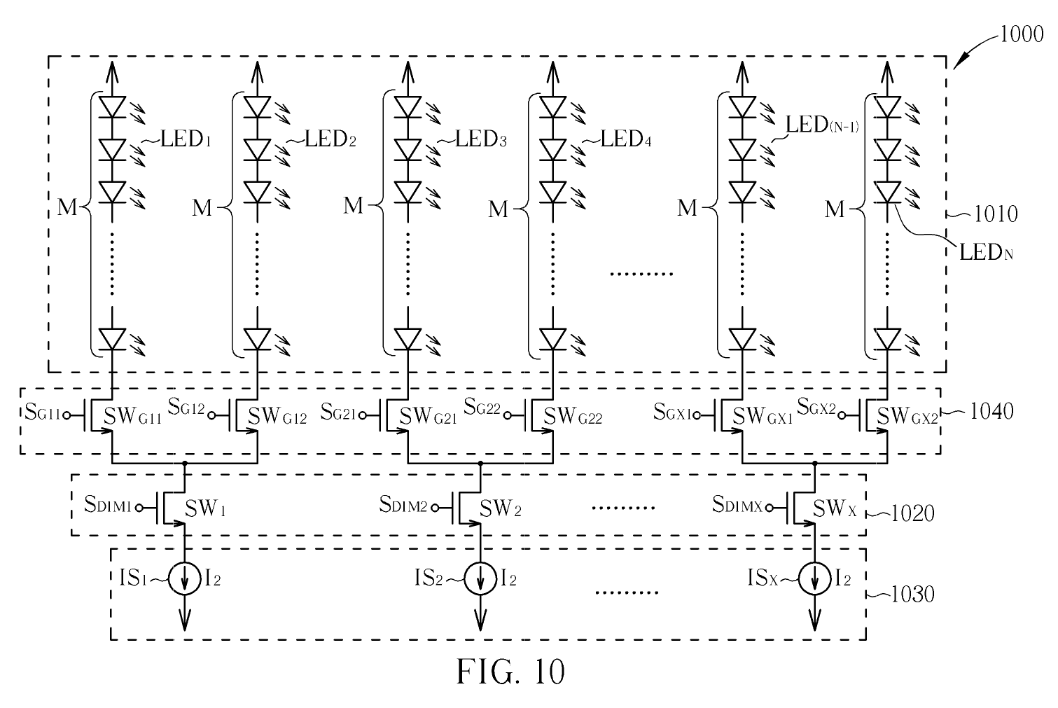

Please refer to FIG. 10. FIG. 10 is a diagram illustrating a light source system 1000 according to a fourth embodiment of the present invention. The light source system 1000 can be applied to the backlight module of an LCD or other similar devices. The light source system 1000 comprises a light module 1010, a dimming module 1020, a current control module 1030, and an interlacing-control module 1040. The light source system 1000 is embodied according to the second embodiment of the present invention. By such manner, compared to the prior art, the light source system 1000 saves the number of the requiring components of the dimming modules and the current control modules, which reduces the cost.

The light module 1010 comprises N LED series (light load) LED₁˜LED_{N}. Each of the LED series LED₁˜LED_{N} can be respectively composed of M LEDs connected in series. For example, the LED series LED₁ comprises M LEDs connected in series.

The dimming module 620 comprises X dimming switches SW₁˜SW_{X}. Each of the dimming switches SW₁˜SW_{X} can be realized with an NMOS transistor. Each of the dimming switches SW₁˜SW_{X} is turned on/off according to its corresponding dimming signal. For example, the dimming switch SW₁ is turned on/off according to the dimming signal S_{DIM1}.

The current control module 1030 comprises X constant current sources IS₁˜IS_{X}. Each of the constant current sources IS₁˜IS_{X} provides a current I₂.

The interlacing-control module 1040 comprises N interlacing-control switches SW_{G11}, SW_{G12}, SW_{G21}, SW_{G22}, SW_{G31}, SW_{G32}, . . . , SW_{GX1}, and SW_{GX2}. The interlacing-control switches SW_{G11}, SW_{G12}, SW_{G21}, SW_{G22}, SW_{G31}, SW_{G32}, . . . , SW_{GX1}, and SW_{GX2} can be realized with NMOS transistors. The interlacing-control switches SW_{G11}, SW_{G12}, SW_{G21}, SW_{G22}, SW_{G31}, SW_{G32}, . . . , SW_{GX1}, and SW_{GX2} are respectively controlled to turn on/off according to the interlacing-control signals S_{G11}, S_{G12}, S_{G21}, S_{G22}, S_{G31}, S_{G32}, . . . , S_{GX1}, and S_{GX2}.

The light source system 1000 can be seen as X light source systems 300. Compared to the components required by the conventional light source system 100 for two LED series, the light source system 300 saves one dimming switch and one constant current source. Therefore, the light source system 1000, compared to the conventional light source system 100, saves X dimming switches and X constant current sources. For example, if the conventional light source system 100 comprises one hundred LED series (N=100), the conventional light source system 100 requires one hundred dimming switches and one hundred constant current sources. However, the light source system 1000 provided by the present invention, under the condition that the number of the LED series is one hundred, only requires fifty dimming switches and fifty constant current sources (X=N/2=100/2=50), which is obviously better than the conventional light source system for reducing cost and provides great convenience. Furthermore, if more LED series are coupled to one single dimming switch and one single constant current source, more dimming switches and constant current sources are saved, which reduces cost more.

To sum up, the light source system provided by the present invention utilizes the design of interlacing-control module to enable different LED series to share one single dimming switch and one single constant current source. In this way, the cost for manufacturing is reduced and the design of the light source system is simplified as well. Thus, users can utilize the light source system of the present invention for applying to the backlight module of an LCD or other devices more conveniently.

Those skilled in the art will readily observe that numerous modifications and alterations of the device and method may be made while retaining the teachings of the invention.

What is claimed is:

1. A light source system, comprising:
a constant current source for providing a predetermined current;
a dimming switch for being turned on or off according to a dimming signal;
a first interlacing-control switch for being turned on or off according to a first interlacing-control switch;
a second interlacing-control switch for being turned on or off according to a second interlacing-control switch;
a first light load for receiving the predetermined current through the first interlacing-control switch and the dimming switch; and
a second light load for receiving the predetermined current through the second interlacing-control switch and the dimming switch.

2. The light source system of claim 1, wherein the first and the second light loads are Light Emitting Diode (LED) series.

3. The light source system of claim 1, wherein when the first interlacing-control signal turns on the first interlacing-control switch, the second interlacing-control signal turns off the second interlacing-control switch; when the second interlacing-control signal turns on the second interlacing-control switch, the first interlacing-control signal turns off the first interlacing-control switch.

4. The light source system of claim 1, wherein the first interlacing-control switch is coupled between a first end of the first light load and the dimming switch; the second interlacing-control switch is coupled between a first end of the second light load and the dimming switch; a second end of the first light load and a second end of the second light load are coupled to a power source; the dimming switch is coupled to the constant current source.

5. The light source system of claim 4, wherein the first and the second interlacing-control switches are N-channel Metal Oxide Semiconductor (NMOS) transistors, and the dimming switch is an NMOS transistor.

6. The light source system of claim 1, wherein the first interlacing-control switch is coupled between a first end of the first light load and a power source; the second interlacing-control switch is coupled to a first end of the second light load and the power source; a second end of the first light load and a second end of the second light load are coupled to the dimming switch; the dimming switch is coupled to the constant current source.

7. The light source system of claim 6, wherein the first and the second interlacing-control switches are P-channel Metal Oxide Semiconductor (PMOS) transistors, and the dimming switch is an NMOS transistor.

8. The light source system of claim 3, wherein when the dimming signal turns on the dimming switch and the first interlacing-control signal turns on the first interlacing-control switch, the first light load receives the predetermined current provided by the constant current source and emits light with luminance according to magnitude of the predetermined current.

9. The light source system of claim 7, wherein the dimming signal is a Pulse Width Modulation (PWM) signal, and duty ratio of the dimming signal is adjustable for adjusting average luminance of the first light load.

10. The light source system of claim 9, wherein the average luminance of the first light load is defined by the duty ratio of the dimming signal and the magnitude of the predetermined current.

11. The light source system of claim 3, wherein when the dimming signal turns on the dimming switch and the second interlacing-control signal turns on the second interlacing-control switch, the second light load receives the predetermined current provided by the constant current source and emits light with luminance according to magnitude of the predetermined current.

12. The light source system of claim 11, wherein the dimming signal is a Pulse Width Modulation (PWM) signal, and duty ratio of the dimming signal is adjustable for adjusting average luminance of the first light load.

13. The light source system of claim 12, wherein the average luminance of the second light load is defined by the duty ratio of the dimming signal and the magnitude of the predetermined current.

14. A light source system, comprising:
a constant current source for providing a predetermined current;
a dimming switch for being turned on or off according to a dimming signal;
a plurality of interlacing-control switches for being turned on or off according to corresponding interlacing-control signals; and
a plurality of light loads, each light load receiving the predetermined current through a corresponding one of the plurality of the interlacing-control switches and the dimming switch.

15. The light source system of claim 14, wherein the plurality of the light loads are LED series.

16. The light source system of claim 14, wherein one of the plurality of the interlacing-control switches is turned on by a corresponding interlacing-control signal, rest of the plurality of the interlacing-control switches are turned off.

17. The light source system of claim 14, wherein one of the plurality of the interlacing-control switches is coupled between a first end of a corresponding one of the plurality of the light loads and the dimming switch; a second end of the corresponding one of the plurality of the light loads is coupled to a power source; the dimming switch is coupled to the constant current source.

18. The light source system of claim 17, wherein the plurality of the interlacing-control switches are NMOS transistors, and the dimming switch is an NMOS transistor.

19. The light source system of claim 14, wherein one of the plurality of the interlacing-control switches is coupled between a first end of a corresponding one of the plurality of the light loads and a power source; a second end of the corresponding one of the plurality of the light loads is coupled to the dimming switch; the dimming switch is coupled to the constant current source.

20. The light source system of claim 19, wherein the plurality of the interlacing-control switches are PMOS transistors, and the dimming switch is an NMOS transistor.

21. The light source system of claim 16, wherein when the dimming signal turns on the dimming switch and one interlacing-control signal turns on a corresponding one of the plurality of the interlacing-control switches, a corresponding one of the plurality of the light loads receives the predetermined current provided by the constant current source and emits light with luminance according to magnitude of the predetermined current.

22. The light source system of claim 21, wherein the dimming signal is a PWM signal, and duty ratio of the dimming signal is adjustable for adjusting average luminance of a corresponding one of the plurality of the light loads.

23. The light source system of claim 22, wherein the average luminance of the corresponding one of the plurality of the light loads is defined by the duty ratio of the dimming signal and the magnitude of the predetermined current.
